(19) United States
(12) Patent Application Publication
(10) Pub. No.: US 2004/0240960 A1
(43) Pub. Date: Dec. 2, 2004

(54) Stradling dowel

(76) Inventor: Aaron Daly, Waldachtal (DE)

Correspondence Address: Striker Striker & Stenby, 103 East Neck Road, Huntington, NY, 11743, US

(21) Appl. No.: 10/484,736

(22) PCT Filed: Jul. 12, 2002
(86) PCT No.: PCT/EP02/07771

(30) Foreign Application Priority Data
Aug. 4, 2001 (DE) 101 34 734.0

(51) Int. Cl. F16B 13/04

(52) U.S. Cl. 411/16

(57) ABSTRACT

The invention relates to an expansible fixing plug having a fixing plug sleeve and an expander screw (10). The invention proposes to align the rear (in the direction of screwing-in) flank (20) of a screw thread (18) of the expander screw (10) at a shallow angle of about 9° relative to the axial direction of the expander screw (10) and to construct the screw thread (18) with a large thread pitch. In the event of the expander screw (10) being subjected to stress in the pull-out direction, the rear flank (20) acts in the manner of expander cones arranged one behind the other axially and expands the fixing plug sleeve. The expansible fixing plug exhibits subsequent expansion behaviour in the event of the drilled hole's becoming wider. In order to counteract unscrewing of the expander screw (10) from the fixing plug sleeve, the invention proposes longitudinally and radially aligned anti-unscrewing flanks (26) on the screw thread (18), which press into the fixing plug sleeve during expansion and thus prevent unscrewing of the expander screw (10) from the fixing plug sleeve.

The invention relates to an expansible fixing plug having the features of the preamble of claim 1.

Expansible fixing plugs of this kind are known per se. They have a fixing plug sleeve into which an expander screw can be screwed, the expander screw widening the fixing plug sleeve as it is screwed in. The fixing plug sleeve usually has longitudinal slots or slots that extend at an angle to the longitudinal direction, which slots divide the fixing plug sleeve into expansion tongues which are pressed apart, or expanded, by screwing in the expander screw, the expansible fixing plug or the fixing plug sleeve being widened or expanded. A further possibility is to produce the fixing plug sleeve from a resiliently and/or plastically widenable material, especially from a plastics material. The widening, or expansion, brings about the anchoring of the expansible fixing plug in a drilled hole, for example in masonry.

A disadvantage of the known expansible fixing plugs is that in the event of a drilled hole's becoming wider, for example as a result of the formation of cracks in the masonry, they become loose and their anchoring or pull-out force is reduced.

The problem underlying the invention is so to construct an expansible fixing plug of the kind mentioned at the beginning that it exhibits high anchoring or pull-out force in the event of a drilled hole's becoming wider.

This problem is solved according to the invention by the features of claim 1. The expander screw of the expansible fixing plug according to the invention has a screw thread, the rear (in the direction of screwing-in) flank of which extends shallowly at an angle of about 45° or less relative to the axial direction of the expander screw. The rear (in the direction of screwing-in) flank of the screw thread forms a sloping or expander surface which additionally widens or expands the fixing plug sleeve in the event of the expander screw's being subjected to an axial load in the pull-out direction. The rear (in the direction of screwing-in) flank forms a cone-like expander body. In respect of its expanding action, the rear (in the direction of screwing-in) flank can be imagined as a number of expander cones arranged one behind the other axially. The screw thread structure has, however, the advantage that the expander screw can be screwed into and out of the fixing plug sleeve.

If a drilled hole in which the expansible fixing plug according to the invention is anchored becomes wider, then—in the event of the expander screw's being subjected to an axial load in the pull-out direction—the expander screw is pulled a short way out of the fixing plug sleeve in the axial direction. In such a case, the rear (in the direction of screwing-in) flank of the screw thread of the expander screw, which flank is at a shallow angle of about 45° or less relative to the axial direction, expands the fixing plug sleeve further. The expansible fixing plug undergoes subsequent expansion and remains anchored in the drilled hole with approximately unchanged anchoring force.

Furthermore, the screw thread of the expander screw of the expansible fixing plug according to the invention has a large thread pitch, the thread pitch corresponding approximately to, or being greater than, the core diameter of the screw thread. There is thus obtained a rear (in the direction of screwing-in) flank of the screw thread that is long in the axial direction. Since, in the event of the expander screw's being displaced relative to the fixing plug sleeve in the pull-out direction, the maximum expansion of the fixing plug sleeve is effected by one thread turn, that is to say the pitch, the invention allows a long pull-out path and, associated therewith, a large degree of subsequent expansion.

The expansible fixing plug according to the invention therefore has the advantages of subsequent expansion behaviour, so that it is suitable for tension zones; a large degree of displaceability of the expander screw relative to the fixing plug sleeve in the pull-out direction until the maximum expansion of the fixing plug sleeve has been reached; and a large degree of maximum expansion of the fixing plug sleeve, so that even when the drilled hole becomes wider by a relatively large amount, it is ensured that the expansible fixing plug is firmly seated in the drilled hole. A further advantage of the expansible fixing plug according to the invention is that it is suitable both for solid building materials, such as, for example, concrete and for hollow building materials, such as, for example, hollow bricks. Its suitability for hollow building materials is achieved because the expander screw expands the fixing plug sleeve uniformly over the entire length of the screw thread, so that the fixing plug sleeve is expanded also in the region of one or more webs of a hollow brick and thus the expansible fixing plug is anchored in the hollow brick. An additional advantage is that the expansible fixing plug according to the invention is introduced into a drilled hole without any rotational movement, for example it can be driven in by means of a hammer or an electrical impact tool. Once the expansible fixing plug has been fully driven into the drilled hole, in order to achieve tensioning and expansion of the expansible fixing plug the expander screw can be tightened, for which purpose rotation through a fraction of a revolution is sufficient. Tightening the expander screw is not necessary, however, because the expansible fixing plug is expanded by an axial load in the pull-out direction, that is to say it is anchored in the drilled hole when subjected to a load.

A variant of the invention provides an anti-unscrewing device which counteracts unscrewing of the expander screw from the fixing plug sleeve. As a result of the large thread pitch it is possible that the screw thread will be non-self-locking. “Non-self-locking” means that axial stress sets the expander screw in rotation and unscrews it from the fixing plug sleeve. The anti-unscrewing device prevents the expander screw from being unscrewed from the fixing plug sleeve by axial stress on the expander screw. As a result, axial stress on the expander screw in the pull-out direction effects expansion and subsequent expansion of the expansible fixing plug. The anti-unscrewing device should preferably allow the expander screw to be unscrewed from the fixing plug sleeve intentionally by driving the expander screw in rotation. Unscrewing of the expander screw from the fixing plug sleeve should be possible preferably at least when the expansible fixing plug is located outside a drilled hole and/or is not expanded. Since the property of being self-locking or non-self-locking, apart from being dependent upon the geometry of the screw thread, is also dependent upon other factors that affect friction, such as the material pairing, state of lubrication, contamination by drill dust or the like, and possibly also temperature and surface pressure, self-locking or non-self-locking is not necessarily a predetermined property but may or may not take effect in the same expansible fixing plug, depending upon the particular in-use conditions. The anti-unscrewing device according to the invention prevents undesired unscrewing of the expander screw from the fixing plug sleeve as a result of axial stress on the expander screw in the pull-out direction when the screw thread is non-self-locking.

A variant of the invention provides on the screw thread of the expander screw an anti-unscrewing flank which extends approximately in the longitudinal direction of the expander screw and approximately radially relative to the expander screw. The anti-unscrewing flank is aligned in the unscrewing direction of the expander screw. The anti-unscrewing flank imparts a sawtooth-shaped cross-section to the screw thread; the anti-unscrewing flank presses into the fixing plug sleeve during expansion and by virtue of its orientation counteracts unscrewing of the expander screw from the fixing plug sleeve. When the fixing plug sleeve is in the non-expanded state, the anti-unscrewing flank does not press, or presses only weakly, into the fixing plug sleeve, so that the expander screw can be unscrewed from the fixing plug sleeve. Screwing the expander screw into the fixing plug sleeve is not impeded by the anti-unscrewing flank.

In a variant of the invention, the anti-unscrewing flank has an edge in common with a flank, for example the rear (in the direction of screwing-in) flank, of the screw thread. In this variant of the invention the anti-unscrewing flank does not project radially beyond the flank of the screw thread and thus does not prevent the expander screw from being intentionally screwed into or unscrewed from the non-expanded fixing plug sleeve. During expansion, the anti-unscrewing flank presses into the fixing plug sleeve and thus prevents undesired unscrewing of the expander screw as a result of axial loading in the pull-out direction.

A variant of the invention provides as anti-unscrewing device a roughened surface on the underside of the screw head of the expander screw. The term “underside” is to be understood as meaning the end face of the screw head facing the screw shank and the screw thread. This variant of the invention can be provided in addition to or as an alternative to the anti-unscrewing flank described above. The roughened surface on the underside of the screw head increases friction between the screw head and an article in contact with its underside affixed using the expander screw of the expansible fixing plug. When the affixed article acts axially in the pull-out direction upon the expander screw on the underside of its screw head, the friction-increasing roughened surface counteracts rotation of the expander screw and thus counteracts unscrewing from the fixing plug sleeve.

In a variant of the invention the roughened surface can be in the form of a knurl or in the form of radial ribbing.

To avoid rotation of the fixing plug sleeve in a drilled hole, a variant of the invention provides anti-rotation elements projecting tangentially from the fixing plug sleeve.

The invention is described in greater detail below with reference to an exemplary embodiment shown in the drawing:

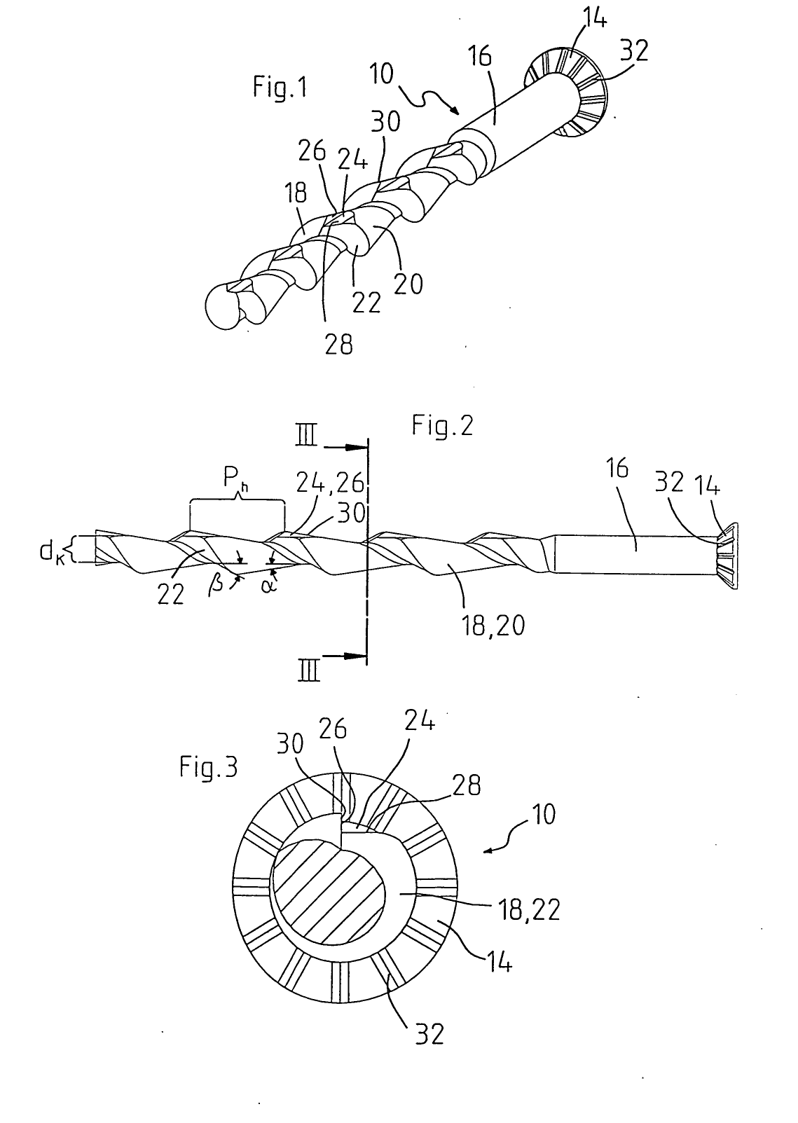

FIG. 1 is a perspective view of an expander screw of an expansible fixing plug according to the invention;

FIG. 2 is a side view of the expander screw from FIG. 1;

FIG. 3 is a cross-section through the expander screw from FIGS. 1 and 2 in accordance with line III-III in FIG. 2;

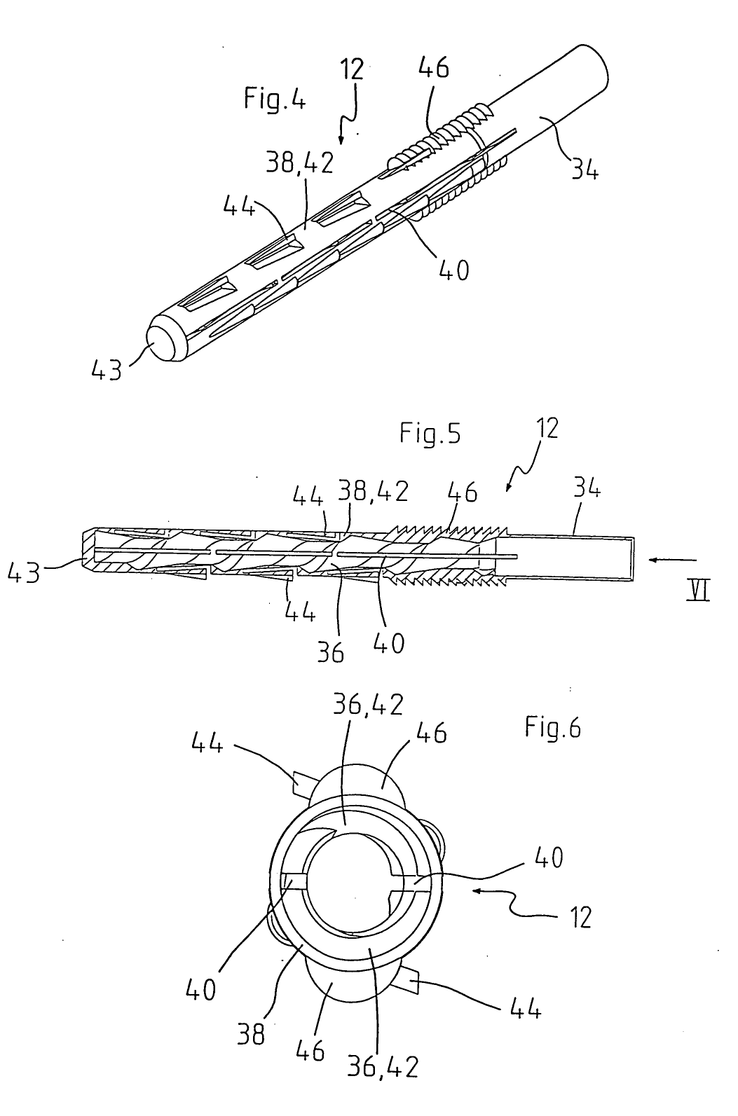

FIG. 4 is a perspective view of a fixing plug sleeve of the expansible fixing plug according to the invention;

FIG. 5 is an axial section through the fixing plug sleeve from FIG. 4; and

FIG. 6 is an end view of the rear end of fixing plug sleeve from FIGS. 4 and 5 in accordance with arrow VI in FIG. 5.

The expansible fixing plug according to the invention shown in the drawing has an expander screw 10, which is made, for example, from steel and is shown in FIGS. 1 to 3, and an expansible sleeve 12, which preferably consists of plastics material and is shown in FIGS. 4 to 6. The expander screw 10 has a screw head 14, an unthreaded screw shank 16 and a screw thread 18 which are integral with one another. The screw thread 18 is single-threaded and has a large thread pitch Pₕ, which in the exemplary embodiment shown and described corresponds to approximately 4½ times the core diameter dₖ. The rear (in the direction of screwing-in) flank 20 of the screw thread 18 is at a shallow angle α of about 9° relative to the axial direction of the expander screw 10. The rear (in the direction of screwing-in) flank 20 is a flank 20 of the screw thread 18 facing the screw head 14. As a result of the shallow angle α of the rear (in the direction of screwing-in) flank 20 of the screw thread 18, the rear flank 20 is cone-like in shape.

The forward (in the direction of screwing-in) flank 22 of the screw thread 18 is aligned considerably more steeply; in the exemplary embodiment of the invention shown and described it is at an angle β of about 30° relative to the axial direction of the expander screw 10.

At a point on the circumference there is provided a milled-out portion 24 that is rectangular in the cross-section of the expander screw 10. The depth of the milled-out portion 24 is less than the height of the screw thread. The milled-out portion 24 therefore does not extend inwards as far as the core of the screw thread 18. The milled-out portion 24 is repeated once per pitch Pₕ.

As is readily discernible in the cross-sectional view of the expander screw 10 shown in FIG. 3, the milled-out portion 24 has a radially aligned flank 26 and a tangentially aligned flank 28. The radially aligned flank 26 faces the unscrewing direction of the expander screw 10; in the case of a right-hand thread the radially directed flank 26 points in the direction of a left-hand rotation. The radial flank 26 of the milled-out portion 24 is referred to hereinafter as the anti-unscrewing flank 26. The milled-out portion 24 imparts a sawtooth-like appearance to the cross-section of the screw thread 18 of the expander screw 10 shown in FIG. 3 in the region of the anti-unscrewing flank 26. The anti-unscrewing flank 26 has an edge 30 in common with the rear (in the direction of screwing-in of the expander screw 10) flank 20 of the screw thread 18.

On its underside, the screw head 14 has a knurl 32 with radial knurling. The underside of the screw head 14 is the end face of the screw head 14 facing the shank 16 and the screw thread 18.

The fixing plug sleeve 12 of the expansible fixing plug according to the invention shown in FIGS. 4 to 6, as can be seen especially in FIG. 5, has an unthreaded hollow shank portion 34 at its rear or pilot end, which is open for the introduction of the expander screw 10. The hollow shank portion 34 is of approximately the same length as the unthreaded shank 16 of the expander screw 10; when the expander screw 10 has been introduced into the fixing plug sleeve 12, the unthreaded shank 16 of the expander screw 10 is located in the unthreaded hollow shank portion 34 of the fixing plug sleeve 12. Towards the front, the unthreaded hollow shank portion 34 is followed by an integral hollow shank portion 38 having an internal thread 36. The internal thread 36 is shaped to be complementary to the screw thread 18 of the expander screw 10. In the hollow shank portion 38 having the internal thread 36, the fixing plug sleeve 12 has non-continuous longitudinal slots 40 which divide the fixing plug sleeve 12 into expansion tongues 42. The hollow shank portion 38 having the internal thread 36 and the longitudinal slots 40 is therefore also referred to hereinafter as the expansion region 38. In the exemplary embodiment shown, the fixing plug sleeve 12 has two longitudinal slots 40 arranged opposite one another which divide the fixing plug sleeve 12 in the expansion region 38 into two expansion tongues 42 which each extend over about 180° in the circumferential direction. The forward or insertion end 43 of the fixing plug sleeve 12 is of closed configuration.

Each of the two expansion tongues 42 has a number of lugs 44, triangular in plan view, arranged one behind the other in the longitudinal direction of the fixing plug sleeve 12. The lugs 44 project approximately tangentially in one direction, as can readily be seen in the end view of the fixing plug sleeve 12 shown in FIG. 6. The lugs 44 form anti-rotation elements which counteract rotation of the fixing plug sleeve 12 in a drilled hole.

The fixing plug sleeve 12 has a number of radially projecting barb elements 46 arranged one behind the other in the longitudinal direction of the fixing plug sleeve 12. The barb elements 46 are arranged in a rear portion of the expansion region 38 and a forward portion of the unthreaded hollow shank portion 34. In the axial section according to FIG. 5, the barb elements 46 are sawtooth-shaped; they form a “pine tree” profile and counteract withdrawal of the fixing plug sleeve 12 from a drilled hole.

The functioning and use of the expansible fixing plug comprising the expander screw 10 and the fixing plug sleeve 12 in accordance with the invention are as follows: to use the expansible fixing plug, the expander screw 10 is introduced into the fixing plug sleeve 12 by being screwed in, the expander screw not being tightened in order that the fixing plug sleeve 12 be not expanded. It is also possible to use the expander screw 10 as a core for injection-moulding the fixing plug sleeve 12. In that case the expander screw 10 is already present in the fixing plug sleeve 12 after the fixing plug sleeve 12 has been produced. With the expander screw 10 installed in the fixing plug sleeve 12, the expansible fixing plug is ready to use; this is the delivery state of the expansible fixing plug. For anchoring in a drilled hole in, for example, masonry (not shown), the expansible fixing plug, that is to say the fixing plug sleeve 12 with the expander screw 10 inside it, is driven through a through-hole in an article (not shown) being affixed to the masonry and into the drilled hole in the masonry, for example using a hammer or an electrical impact tool. The expansible fixing plug is driven into the drilled hole to a depth such that the screw head 14 is seated with its underside on the article being affixed. When the expansible fixing plug is being driven in, the forward (in the direction of screwing-in) flank 22 of the thread 18 of the expander screw 10 acts as a counter-bearing or driver element which, by positive engagement, transmits a driving-in force to the fixing plug sleeve 12 and thus drives the fixing plug sleeve 12 into the drilled hole. Anchoring of the expansible fixing plug in the drilled hole is completed by the driving-in; tightening by rotation of the expander screw 10 is unnecessary. After the driving-in, the expander screw 10 can, however, be tightened in order to effect expansion and tensioning of the expansible fixing plug 10, 12. For tightening, a fraction of a revolution of the expander screw 10 is sufficient.

When the expander screw 10 is subjected to a load axially in the pull-out direction, the rear (in the direction of screwing-in) flank 20 aligned at a shallow angle α relative to the axial direction acts in the manner of a conical surface; it presses the expansion tongues 42 of the fixing plug sleeve 12 apart. The fixing plug sleeve 12 is expanded and the expansible fixing plug 10, 12 is anchored in the drilled hole. The screw thread 18 of the expander screw 10 can, with its rear flank 20 aligned at a shallow angle α relative to the axial direction, be regarded, in respect of its expanding action, as a number of expander cones arranged one behind the other axially, which expand the fixing plug sleeve 12 in the expansion region 38 as a result of axial stress on the expander screw 10 in the pull-out direction. In the event of the drilled hole's becoming wider, for example as the result of the formation of cracks in the masonry, the expander screw 10, when subjected to stress axially in the pull-out direction, expands the fixing plug sleeve 12 further, so that, in the event of the drilled hole's becoming wider, the expansible fixing plug 10, 12 remains anchored in the drilled hole with its anchoring force almost unchanged. The expansible fixing plug 10, 12 exhibits subsequent expansion behaviour; it is suitable for tension zones. The large thread pitch Pₕ of the expander screw 10 renders permissible a correspondingly large displacement of the expander screw 10 in respect of the fixing plug sleeve 12 in the pull-out direction for expansion and subsequent expansion. The large thread pitch Pₕ prevents the expander screw 10 from being pulled out of the fixing plug sleeve 12 by a thread pitch Pₕ, in which case the fixing plug sleeve 12 with its internal thread 36 displaced by a turn would “snap into” the screw thread 18 and the expansion would be cancelled.

By virtue of the large thread pitch Pₕ, self-locking of the expander screw 10 in the fixing plug sleeve 12 cannot be ruled out in every case. “Non-self-locking” means that when the expander screw is acted upon axially in the pull-out direction, the expander screw 10 is rotated in the unscrewing direction and the expander screw 10 is unscrewed from the fixing plug sleeve as a result of the axial stress. In order to avoid that situation, the anti-unscrewing flanks 26 described above are provided on the thread turns of the screw thread 18. The edges 30 of the anti-unscrewing flanks 26 press into the fixing plug sleeve 12 during expansion of the fixing plug sleeve 12. For that purpose it is unnecessary for the anti-unscrewing flanks 26 to project radially beyond the flanks 20, 22 of the screw thread 18. The anti-unscrewing flanks 26 pressed into the fixing plug sleeve 12 form counter-bearings which counteract unscrewing of the expander screw as a result of axial loading on the expander screw 10 in the pull-out direction when the screw thread 18 and the internal thread 36 of the fixing plug sleeve 12 are non-self-locking. The anti-unscrewing flanks 26 thus form an anti-unscrewing device of the expansible fixing plug 10, 12.

When the expansible fixing plug 10, 12 is in the non-expanded state and, especially, is not located in a drilled hole, the edges 30 of the anti-unscrewing flanks 26 do not press into the fixing plug sleeve, so that the expander screw 10 can be unscrewed from the fixing plug sleeve 12.

A further anti-unscrewing device is formed by the knurl 32 on the underside of the screw head 14. When the expander screw 10 is acted upon axially in the pull-out direction by an article affixed thereby to a wall, the article is in contact with the underside of the screw head 14 having the knurl 32. If the article does not rotate, friction between the screw head 14 and the article, which is increased by the knurl 32, counteracts rotation of the expander screw 10, that is to say especially counteracts unscrewing of the expander screw 10 from the fixing plug sleeve 12 when the screw thread 18 is non-self-locking.

The rear flank 20 of the screw thread 18 aligned at a shallow angle α relative to the axial direction of the expander screw, which flank 20 acts in the manner of expander cones arranged one behind the other axially, expands the fixing plug sleeve uniformly over the entire length of its expansion region 38. The expansible fixing plug 10, 12 according to the invention, in addition to being suitable for solid building materials, is therefore also suitable for hollow building materials, such as, for example, hollow bricks, because the uniform expansion over the entire length of the expansion region 38 effects expansion in the region of at least one web of the hollow brick, which expansion anchors the expansible fixing plug 10, 12 in the hollow brick.

1. Expansible fixing plug having an expansible fixing plug sleeve and an expander screw for expanding the fixing plug sleeve, characterised in that the expander screw (10) has a screw thread (18), the rear (in the direction of screwing-in) flank (20) of which is at a shallow angle (α) of about 45° or less relative to the axial direction of the expander screw (10), and the screw thread (18) has a large thread pitch (Pₕ) which corresponds to, or is greater than, approximately one core diameter (dₖ) of the screw thread (18).

2. Expansible fixing plug according to claim 1, characterized in that the rear (in the direction of screwing-in) flank (20) of the screw thread (18) of the expander screw extends at an angle (α) of about 9° to the axial direction of the expander screw (10).

3. Expansible fixing plug according to claim 1, characterised in that the thread pitch (Pₕ) of the screw thread (18) of the expander screw (10) is more than twice as large as the core diameter (dₖ) of the screw thread (18).

4. Expansible fixing plug according to claim 3, characterised in that the thread pitch (Pₕ) of the screw thread (18) of the expander screw (10) is approximately four and a half times the core diameter (dₖ) of the screw thread (18).

5. Expansible fixing plug according to claim 1, characterised in that the expansible fixing plug (10, 12) has an anti-unscrewing device (26; 32) which counteracts unscrewing of the expander screw (10) from the fixing plug sleeve (12).

6. Expansible fixing plug according to claim 5, characterised in that a thread turn of the screw thread (18) has, at at least one point, an anti-unscrewing flank (26) which extends approximately in the longitudinal direction of the expander screw (10) and which is aligned approximately radially relative to the expander screw (10) and which faces the unscrewing direction of the expander screw (10).

7. Expansible fixing plug according to claim 6, characterised in that the anti-unscrewing flank (26) has an edge (30) in common with a flank (20, 22) of the screw thread (18).

8. Expansible fixing plug according to claim 5, characterised in that the expander screw (10) has a screw head (14), the underside of which has a roughened surface (32).

9. Expansible fixing plug according to claim 8, characterised in that the screw head (14) has a knurl (32) as the roughened surface on its underside.

10. Expansible fixing plug according to claim 8, characterised in that the screw head (14) has radial ribbing as the roughened surface on its underside.

11. Expansible fixing plug according to claim 1, characterised in that the fixing plug sleeve (12) has anti-rotation elements (44) projecting approximately tangentially.

12. Expansible fixing plug according to claim 1, characterised in that the expander screw (10) is pre-mounted in the fixing plug sleeve (12).
